(19) United States
(12) Patent Application Publication
(10) Pub. No.: US 2010/0239198 A1
(43) Pub. Date: Sep. 23, 2010

(54) BEARING DEVICE OF COMPRESSOR FOR REFRIGERATOR

(75) Inventor: Hideki IWATA, Inuyama (JP)

Correspondence Address: BROWDY AND NEIMARK, P.L.L.C.;624 NINTH STREET, NW, SUITE 300, WASHINGTON, DC, 20001-5303, US

(73) Assignee: DAIDO METAL COMPANY LTD., Naka-ku (JP)

(21) Appl. No.: 12/726,488

(22) Filed: Mar. 18, 2010

(30) Foreign Application Priority Data
Mar. 19, 2009 (JP) 2009-067526

(51) Int. Cl. F16C 25/00; F16C 33/10

(52) U.S. Cl. 384/261; 384/322

(57) ABSTRACT

The invention provides a bearing device of a compressor for a refrigerator which can widen a clearance between a sliding surface of a bearing and a surface of a crank shaft at a time of starting, while narrowing the clearance between the sliding surface of the bearing and the surface of the crank shaft at a time of a regular operation of the compressor for the refrigerator. A thickness of a resin sliding layer is set in such a manner that a bearing clearance at a starting time becomes relatively larger than a bearing clearance at a regular operating time within a range which is equal to or more than 2.5% and is equal to or less than 20%. Accordingly, since the bearing clearance becomes larger within the range which is equal to or more than 2.5% and is equal to or less than 20% at the starting time with respect to the regular operating time, while narrowing the bearing clearance for preventing a compression efficiency of the compressor for the refrigerator from being lowered due to a deflection of an axis of a crank shaft, at the regular operating time, it is possible to prevent a sliding surface of a bearing and a surface of the crank shaft from coming into direct contact with each other.

### BACKGROUND OF THE INVENTION

(1) Field of the Invention

The present invention relates to a bearing device of a compressor for a refrigerator structured such that a cylindrical bearing having a steel back layer and a resin sliding layer rotatably supports a shaft via a clearance.

(2) Description of Related Art

As the compressor for the refrigerator, there are various compressors such as a scroll type compressor, a rotary type compressor and the like, however, whichever type has such a structure that a bearing supports a crank shaft (a rotating shaft) via a clearance. In the bearing of the compressor for the refrigerator, there is employed a cylindrical bearing or the like constructed by a multiple layers in which a porous metal sintered layer is formed on the steel back layer, and a resin composition is impregnated into voids of the porous sintered metal sintered layer. Further, the bearing of the compressor for the refrigerator is done machining (cutting or grinding) in its bearing inner diameter in a state in which the bearing is pressed into a bearing housing portion, in such a manner that a clearance between a sliding surface of the bearing and a crank shaft becomes narrow, in order to prevent a compression efficiency from being lowered by a deflection of an axis of the crank shaft at a time of a regular operation.

Further, as a conventional bearing of a compressor for a refrigerator, there has been proposed a bearing in which a porous metal sintered layer is sparsely exposed to a sliding surface. For example, an improvement of an abrasion resistance and an anti-seizure property of a bearing is intended by sparsely exposing a porous metal sintered layer to a sliding surface, in a main bearing or a lower bearing of a crank shaft of a compressor for a refrigerator in JP-A-59-194128 (patent document 1), and in a bearing of an eccentric portion of a crank shaft in JP-B2-3823325 (patent document 2).

In this case, a lubrication of the sliding surface of the bearing of the compressor for the refrigerator is achieved by feeding a refrigerant or a refrigerating machine oil to a clearance between a sliding surface of the bearing and a surface of the crank shaft, however, since the feeding amount is poor at a time of starting the compressor for the refrigerator, and the clearance between the sliding surface of the bearing and the surface of the crank shaft is designed to be narrow, a direct contact between the sliding surface of the bearing and the surface of the crank shaft is apt to be generated. The bearing in which the porous metal sintered layer is sparsely exposed to the sliding surface, as disclosed in the patent documents 1 and 2 mentioned above, can obtain a satisfactory performance at a time of a regular operation, however, since the direct contact between the porous sintered metal sparsely exposed to the sliding surface and the surface of the shaft is generated at a time of starting, an abrasion and a seizure of the bearing is apt to be generated. Further, it is possible to reduce the contact between the sliding surface of the bearing and the surface of the crank shaft at a time of starting, by enlarging the clearance between the sliding surface of the bearing and the surface of the crank shaft, however, since a reduction of the compression efficiency is generated due to the deflection of the axis of the crank shaft, at a time of the regular operation, it can not come to a practical solving method.

### BRIEF SUMMARY OF THE INVENTION

The present invention is made by taking the circumstances mentioned above into consideration, and an object of the present invention is to provide a bearing device of a compressor for a refrigerator which can widen a clearance between a sliding surface of a bearing and a surface of a crank shaft at a time of starting, while narrowing the clearance between the sliding surface of the bearing and the surface of the crank shaft at a time of a regular operation of the compressor for the refrigerator.

In order to achieve the object mentioned above, in accordance with a first aspect of the present invention, there is provided a bearing device of a compressor for a refrigerator in which a cylindrical bearing comprising a steel back layer and a resin sliding layer rotatably supports a shaft via a clearance, wherein a thickness L (mm) of the resin sliding layer at a time of starting is set to the following range, with respect to a clearance C1 (mm) between the sliding surface of the bearing and the surface of the shaft at a time of a regular operation, a bearing temperature T2 (K) of the bearing at a time of the regular operation, a bearing temperature T1 (K) of the bearing at a time of starting, and a thermal expansion coefficient α (K−1) of a resin composition of the resin sliding layer:

C1×0.025/{(T2−T1)×α}≦L≦C1×0.20/{(T2−T1)×α}.

In accordance with a second aspect of the present invention, there is provided a bearing device of a compressor for a refrigerator as recited in the first aspect, wherein a porous metal sintered layer is formed on a steel back layer, and the resin sliding layer is coated on the porous metal sintered layer.

In accordance with a third aspect of the present invention, there is provided a bearing device of a compressor for a refrigerator as recited in the first aspect or the second aspect, wherein the resin sliding layer employs a resin having a thermal expansion coefficient which is relatively twentyfold or larger than a thermal expansion coefficient of a material of the shaft.

In accordance with a fourth aspect of the present invention, there is provided a bearing device of a compressor for a refrigerator as recited in any one of the first aspect to the third aspect, wherein a resin composition of the resin sliding layer is constructed by any one or more of a polyimide, a polyamide-imide and a polybenzimidazole.

In accordance with a fifth aspect of the present invention, there is provided a bearing device of a compressor for a refrigerator as recited in any one of the first aspect to the fourth aspect, wherein 1 to 40 weight % of solid lubricant is included in the resin sliding layer.

In accordance with a sixth aspect of the present invention, there is provided a bearing device of a compressor for a refrigerator as recited in the fifth aspect, wherein the solid lubricant is comprised by any one or more of a molybdenum disulfide, a tungsten disulfide, a graphite, and a polytetrafluoroethylene.

In accordance with a seventh aspect of the present invention, there is provided a bearing device of a compressor for a refrigerator as recited in the sixth aspect, wherein in the case that the polytetrafluoroethylene is included as the solid lubricant, it is included further by 0.1 to 15 weight % of at least one compound selected from a calcium phosphate, a barium phosphate, a magnesium phosphate, a lithium phosphate, a tribasic lithium phosphate, a tribasic calcium phosphate, a calcium hydrogen phosphate or anhydrate, a magnesium hydrogen phosphate or anhydrate, a lithium pyrophosphate, a calcium pyrophosphate, a magnesium pyrophosphate, a lithium metaphosphate, a calcium metaphosphate, a magnesium metaphosphate, a lithium carbonate, a magnesium carbonate, a calcium carbonate, a strontium carbonate, a barium carbonate, a calcium sulfate and a barium sulfate.

### EFFECT OF THE INVENTION

In the invention in accordance with the first aspect, a thermal expansion deformation is generated in the resin sliding layer on the basis of the temperature difference between the starting time and the regular operating time of the compressor for the refrigerator, however, since a deformation of the resin sliding layer to a bearing outer diameter side is constrained by the steel back having a relatively higher strength than the resin sliding layer, the deformation of the resin sliding layer to an inner diameter side is generated. Accordingly, in the case that the thickness of the resin sliding layer is set within the range of the expression described in the first aspect, a clearance between the sliding surface and the shaft surface of the bearing at the starting time becomes relatively larger within a range which is equal to or more than 2.5% and is equal to or less than 20%, with respect to a clearance between the sliding surface and the shaft surface at the regular operating time. Accordingly, since the clearance between the sliding surface of the bearing and the shaft surface (hereinafter, refer to as a bearing clearance) becomes larger within the range which is equal to or more than 2.5% and is equal to or less than 20% at the starting time with respect to the regular operating time, while narrowing the bearing clearance for preventing the compression efficiency of the compressor for the refrigerator from being lowered due to the deflection of the axis of the shaft in the same manner, at the regular operating time, it is possible to prevent the sliding surface of the bearing and the shaft surface from coming into direct contact with each other, and it is possible to make it hard to generate an abrasion and a seizure of the sliding surface of the bearing.

On the contrary, in the case that an increase of the bearing clearance at the starting time in comparison with the regular operating time is less than 2.5%, an effect of preventing the sliding surface of the bearing and the shaft surface from coming into contact is insufficient, and if it goes beyond 20%, the bearing clearance becomes excessively too large, so that the axis of the shaft deflects at the starting time, a collision (a beating) with the sliding surface of the bearing is generated, and there is a case that the sliding surface of the bearing is damaged. In this case, it is more preferable to set a thickness of the resin sliding layer in such a manner that the bearing clearance at the starting time becomes larger than the bearing clearance at the regular operating time within a range which is equal to or more than 5% and is equal to or less than 15% with respect to the bearing clearance at the regular operating time.

In this case, as disclosed in the patent documents 1 and 2 mentioned above, in the case of the bearing in which the porous metal sintered layer is exposed to the sliding surface, a difference of the thermal expansion deformation is hardly generated between the porous sintered metal layer and the crank shaft (generally made of an iron alloy), even if a temperature difference is generated between the starting time and the regular operating time of the compressor for the refrigerator. Accordingly, the bearing clearance at the starting time is narrow in the same manner as the regular operating time. Therefore, since the direct contact between the porous metal sintered layer exposed to the sliding surface of the bearing and the shaft surface is generated during a while the refrigerant or the refrigerating machine oil is not sufficiently fed to the bearing clearance at the starting time, the abrasion and the seizure of the sliding surface of the bearing is apt to be generated.

Further, the porous metal sintered layer may be formed as an intermediate layer on the steel back layer, and the resin of the resin sliding layer may be impregnated into voids of the porous metal sintered layer, for enhancing a bonding strength between the steel back layer and the resin sliding layer, such as the invention in accordance with the second aspect. In this case, it is possible to obtain the same effect as the case that the resin sliding layer is directly coated on the steel back layer, by controlling a thickness of the resin sliding layer coated on the porous metal sintered layer. In this case, it is possible to use a sintered layer of a general metal such as a copper alloy sintered layer, an iron alloy sintered layer or the like. Further, it is preferable to make a void ratio of the porous sintered layer equal to or more than 20 volume % for enhancing the bonding strength with the resin sliding layer.

Further, if there is employed the resin in which the difference of the thermal expansion coefficient between the resin of the resin sliding layer and the material of the shaft is relatively twentyfold or larger, such as the invention in accordance with the third aspect, the thermal expansion deformation of the resin sliding layer at the starting time becomes larger in comparison with the regular operating time. Accordingly, it becomes easy to control the bearing clearance. In this case, the material of the shaft of the compressor for the refrigerator is generally an iron alloy, and a thermal expansion coefficient thereof is in the vicinity of 11×10⁻⁶ K⁻¹. In this case, it is desirable to use a resin of the resin sliding layer in which a thermal expansion coefficient is equal to or more than 4.0×10⁻⁵ K⁻¹, and it is more desirable to employ a resin in which it is equal to or more than 6.0×10⁻⁵ K⁻¹, and it is further desirable to employ a resin in which it is equal to or more than 8.0×10⁻⁵ K⁻¹. Specifically, it is possible to employ any one or more resin of a polyether ether ketone, a polyacetal, a polyamide, a phenol, a polyimide, a polyamide-imide and a polybenzimidazole.

Further, it is preferable that the resin composition of the resin sliding layer is constructed by any one or more of the polyimide, the polyamide-imide and the polybenzimidazole, such as the invention in accordance with the fourth aspect. These resins are preferable as the sliding layer of the bearing of the compressor for the refrigerator in which the bearing comes to a high temperature, since a thermostability is high, and a high-temperature strength is high. In other words, if these resins are used, the abrasion of the sliding surface of the bearing is small, and the reduction of the compression efficiency caused by the axial deflection of the shaft is hard to be generated.

Further, the solid lubricant may be included at 1 to 40 weight % in the resin sliding layer, for enhancing a sliding performance of the resin sliding layer, such as the invention in accordance with the fifth aspect. Further, it is possible to employ any one or more of the molybdenum disulfide, the tungsten disulfide, the graphite, and the polytetrafluoroethylene (hereinafter, refer to as “PTFE”) as the solid lubricant, such as the invention in accordance with the sixth aspect. In this case, since the thermal expansion coefficient is small in the molybdenum disulfide, the tungsten disulfide and the graphite among the solid lubricant in comparison with the resin, the thermal expansion deformation of the resin sliding layer becomes smaller at the starting time with respect to the regular operating time. Therefore, if the content of the solid lubricant goes beyond 40 weight %, an increasing amount of the bearing clearance at the starting time becomes too small, and the direct contact between the sliding surface of the bearing and the shaft surface is apt to be generated. Accordingly, it is preferable that the content is equal to or less than 40 weight %.

Further, since the PTFE is a resin type solid lubricant in the same manner as the resin sliding layer, and a thermal expansion deformation amount thereof is large, the PTFE is most preferable as the solid lubricant which is used in the present invention. In the case of using a resin having a thermal expansion coefficient which is relatively lower in comparison with the PTFE, as the resin composition of the resin sliding layer, it is necessary to take into consideration a thermal expansion deformation of the resin sliding layer in correspondence to a volume rate of the PTFE in the resin sliding layer.

Further, in the case that the PTFE is included in the solid lubricant, it may be included further by 0.1 to 15 weight % of at least one compound selected from the calcium phosphate, the barium phosphate, the magnesium phosphate, the lithium phosphate, the tribasic lithium phosphate, the tribasic calcium phosphate, the calcium hydrogen phosphate or anhydrate, the magnesium hydrogen phosphate or anhydrate, the lithium pyrophosphate, the calcium pyrophosphate, the magnesium pyrophosphate, the lithium metaphosphate, the calcium metaphosphate, the magnesium metaphosphate, the lithium carbonate, the magnesium carbonate, the calcium carbonate, the strontium carbonate, the barium carbonate, the calcium sulfate and the barium sulfate, for enhancing a lubricating characteristic of the PTFE, such as the invention in accordance with the seventh aspect.

### BRIEF DESCRIPTION OF THE SEVERAL VIEWS OF THE DRAWING

FIG. 1A is a cross sectional view showing a relationship between a crank shaft and a bearing at a time of a regular operation of a compressor for a refrigerator;

FIG. 1B is a cross sectional view showing a relationship between the crank shaft and the bearing at a time of starting;

FIG. 2 is a schematic view of a cross section of a bearing in which a resin sliding layer is directly coated on a steel back layer; and

FIG. 3 is a schematic view of a cross section of a bearing in which a porous metal sintered layer is formed as an intermediate layer on the steel back layer, and the resin sliding layer is coated on the porous metal sintered layer.

### DETAILED DESCRIPTION OF THE INVENTION

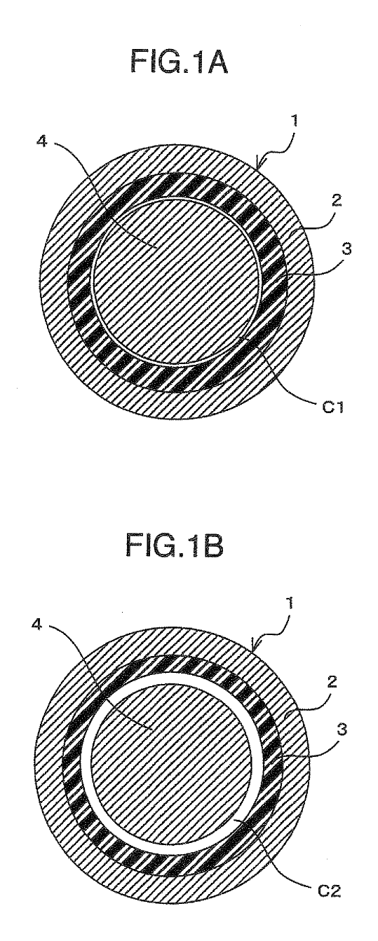

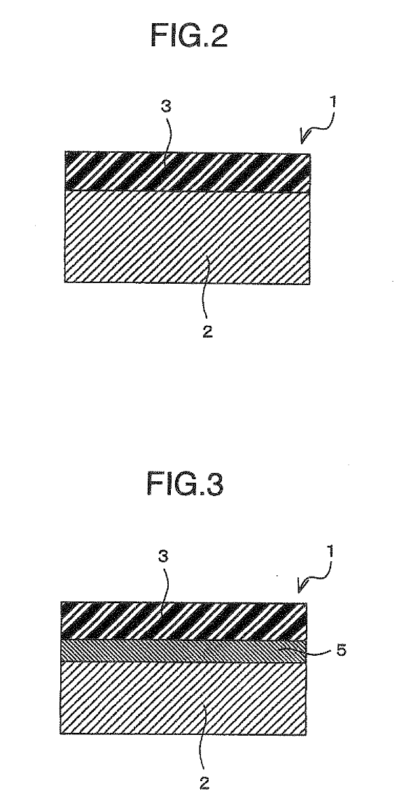

A description will be given below of an embodiment in accordance with the present invention with reference to FIGS. 1 to 3. FIG. 1A is a cross sectional view showing a relationship between a crank shaft 4 and a bearing 1 at a time of a regular operation of a compressor for a refrigerator, FIG. 1B is a cross sectional view showing a relationship between the crank shaft 4 and the bearing 1 at a time of starting the compressor for the refrigerator, FIG. 2 is a schematic view of a cross section of the bearing 1 in which a resin sliding layer 3 is directly coated on a steel back layer 2, and FIG. 3 is a schematic view of a cross section of the bearing 1 in which a porous metal sintered layer 5 is formed as an intermediate layer on the steel back layer 2, and the resin sliding layer 3 is coated on the porous metal sintered layer 5. In this case, the drawings mentioned above are the schematic drawings of the crank shaft 4 and the bearing 1 in accordance with the embodiment, and each of the portions is drawn rhetorically or in an abbreviated manner for easily understanding a structure, a construction and the like.

As shown in FIG. 2, the bearing 1 of the compressor for the refrigerator in accordance with the present embodiment is structured such that the resin sliding layer 3 is provided on the steel back layer 2. Further, as shown in FIG. 1A, the bearing 1 is formed as a cylindrical shape, and is structured such as to rotatably bear the crank shaft 4 via a bearing clearance C1. Further, a sliding surface of the bearing 1 and a surface of the crank shaft 4 are lubricated by feeding a refrigerant and a refrigerating machine oil to the bearing clearance C1.

In the meantime, a thermal expansion deformation is generated by a temperature difference between a starting time and a regular operating time of the compressor for the refrigerator, in the bearing 1 and the crank shaft 4. In this case, since it is general that a material of the crank shaft 4 of the compressor for the refrigerator is typically made of an iron alloy, the back layer 2 in the bearing 1 in accordance with the present invention is made of a steel. In this case, since the steel back layer 2 of the bearing 1 and the crank shaft 4 go about the same thermal expansion deformation relatively, a distance between an interface between the steel back layer 2 of the bearing 1 and the resin sliding layer 3, and a surface of the crank shaft 4 does not change even if a temperature change is generated. On the contrary, since a thermal expansion deformation caused by a temperature difference between the starting time and the regular operating time of the resin sliding layer 3 is constrained its deformation to an outer diameter side of the bearing 1 by the steel back layer having a relatively higher strength than the resin sliding layer 3, a deformation of the resin sliding layer 3 to an inner diameter side of the bearing 1 is apt to be generated.

In the bearing 1 structured as mentioned above, it is possible to prevent the sliding surface of the bearing 1 and the surface of the crank shaft 4 from coming into direct contact with each other, by enlarging a bearing clearance C2 (mm) between the sliding surface of the bearing 1 and the surface of the crank shaft 4 at the starting time with respect to a bearing clearance C1 (mm) between the sliding surface of the bearing 1 and the surface of the crank shaft 4 at the regular operating time, on the basis of an expression C1×1.025≦C2≦C1×1.20, that is, enlarging the bearing clearance C2 at the starting time with respect to the bearing clearance C1 at the regular operating time within a range which is equal to or more than 2.5% and is equal to or less than 20%, and it is possible to obtain a result of making it hard to generate an abrasion and a seizure of the sliding surface of the bearing 1.

Further, taking into consideration the matter that an amount of expansion (a thickness changing amount) of the resin sliding layer 3 is expressed by C2−C1=(T2−T1)×α×L, with respect to a bearing temperature T2 (K) of the bearing 1 at the regular operating time, a bearing temperature T1 (K) of the bearing 1 at the starting time, a thermal expansion coefficient α (K−1) of a resin composition of the resin sliding layer 3, and a thickness L (mm) of the resin sliding layer 3 at the starting time, it is preferable to set the thickness L (mm) of the resin sliding layer 3 at the starting time within a range express by the following expression (1).

C1×0.025/{(T2−T1)×α}≦L≦C1×0.20/{(T2−T1)×α} (1)

In other words, in the case that the thickness L of the resin sliding layer 3 is set within the range of the expression (1) mentioned above, it is possible to relatively enlarge the bearing clearance C2 at the starting time with respect to the bearing clearance C1 at the regular operating time, within a range which is equal to or more than 2.5% and is equal to or less than 20%. In accordance with this structure, since the bearing clearance C2 becomes larger at the starting time than the regular operating time within the range which is equal to or more than 2.5% and is equal to or less than 20%, while narrowing the bearing clearance C1 for preventing the compression efficiency of the compressor for the refrigerator from being lowered on the basis of the deflection of the axis of the crank shaft 4, at the regular operating time, it is possible to prevent the sliding surface of the bearing 1 and the surface of the crank shaft 4 from coming into direct contact with each other.

On the contrary, in the case that an increase of the bearing clearance C2 at the starting time in comparison with the regular operating time is less than 2.5%, the effect of preventing the sliding surface of the bearing 1 and the surface of the crank shaft 4 from coming into contact is insufficient, and if it goes beyond 20%, the bearing clearance C2 becomes excessively too large, so that the axis of the crank shaft 4 deflects at the starting time, a collision (a beating) with the sliding surface of the bearing 1 is generated, and there is a case that a fretting damage is generated in the sliding surface of the bearing 1. In this case, it is more preferable to set a thickness of the resin sliding layer 3 in such a manner that the bearing clearance C2 at the starting time becomes larger than the bearing clearance C1 at the regular operating time within a range which is equal to or more than 5% and is equal to or less than 15% with respect to the bearing clearance C1 at the regular operating time.

In this case, although being rhetorically drawn in FIG. 1A, the bearing clearance C1 at the regular operating time is set small for preventing the compression efficiency of the compressor for the refrigerator from being lowered on the basis of the deflection of the axis of the rotating crank shaft 4. Specifically, there is a case that a lower limit value of the bearing clearance C1 is different according to specification of the compressor for the refrigerator, however, it is general that it is set to a dimension which is in the vicinity of 0.010 mm. Further, the bearing temperature T2 of the bearing at the regular operating time is slightly different in accordance with the specification of the compressor for the refrigerator, however, for example, in the case of a compressor for a refrigerator for an air conditioning, it is in the vicinity of 150° C. Further, the bearing temperature T1 at the starting time means a temperature of an environment in which the compressor for the refrigerator is installed. For example, in the case of the compressor for the refrigerator for the air conditioning, since it is typically installed in an indoor side or an outdoor side, the temperature is in the vicinity of 20° C. on the average.

In this case, it is preferable that the bearing 1 of the compressor for the refrigerator is set to a thickness of the resin sliding layer 3 in the range of the expression (1), by press fitting the bearing 1 in which the resin sliding layer 3 having the thickness which is equal to or more than the range of the expression (1) is formed, into a bearing housing (not shown), and thereafter applying a machining (a cutting or a grinding) to the inner diameter of the bearing 1, however, the bearing 1 in which the resin sliding layer 3 having the thickness in the range of the expression (1) is formed, may be press fitted to the bearing housing.

Further, the resin composition used in the resin sliding layer 3 has no constraint. Since the thermal expansion coefficient of the resin is larger in comparison with the crank shaft 4 (the iron alloy), it is possible to enlarge the bearing clearance C1 at the starting time in comparison with the bearing clearance C2 at the regular operating time. In this case, the thermal expansion coefficient of the resin is different according to compositions, however, an amount of the thermal expansion deformation may be regulated by controlling the thickness of the resin sliding layer 3. Accordingly, whichever resin composition the resin composition used in the resin sliding layer 3 is, it is possible to enlarge the bearing clearance C1 at the starting time with respect to the bearing clearance C2 at the regular operating time in the range which is equal to or more than 2.5% and is equal to or less than 20%.

Further, the bearing 1 may be structured, as shown in FIG. 3, such that a porous metal sintered layer 5 is formed as an intermediate layer on the steel back layer 2, and the resin of the resin sliding layer 3 is impregnated into voids of the porous sintered layer 5, for enhancing a bonding strength between the steel back layer 2 and the resin sliding layer 3. In this case, it is possible to obtain the same effect as the case that the resin sliding layer 3 is directly coated on the steel back layer 2 shown in FIG. 2, by controlling the thickness of the resin sliding layer 3 coated on the porous metal sintered layer 5. In this case, it is possible to use a sintered layer of a general metal such as a copper alloy sintered layer, an iron alloy sintered layer or the like, as the porous metal sintered layer 5. Further, it is preferable to make a void ratio of the porous sintered layer 5 equal to or more than 20 volume % for enhancing the bonding strength with the resin sliding layer 3.

Further, it is preferable to use a resin having a thermal expansion coefficient which is relatively twentyfold or larger than a thermal expansion coefficient of a material of the crank shaft 4, in the resin sliding layer 3. Since the thermal expansion deformation of the resin sliding layer 3 at the starting time becomes larger in comparison with the regular operating time, by using the resin in which the difference of the thermal expansion coefficient between the resin of the resin sliding layer 3 and the material of the crank shaft 4 is relatively twenty fold or larger, it becomes easy to control the bearing clearance. In this case, the iron alloy is typically used as the material of the crank shaft 4 for the compressor for the refrigerator, and the thermal expansion coefficient thereof is in the vicinity of 11×10⁻⁶ K⁻¹. In this case, it is desirable to use the resin of the resin sliding layer 3 in which the thermal expansion coefficient is equal to or more than 4.0×10⁻⁵ K⁻¹, it is more desirable to employ a resin in which it is equal to or more than 6.0×10⁻⁵ K⁻¹, and it is further desirable to employ a resin in which it is equal to or more than 8.0×10⁻⁵ K⁻¹. Specifically, it is possible to employ any one or more resin of a polyether ether ketone, a polyacetal, a polyamide, a phenol, a polyimide, a polyamide-imide and a polybenzimidazole.

Further, it is preferable that the resin composition of the resin sliding layer 3 is constructed by any one or more of the polyimide, the polyamide-imide and the polybenzimidazole. These resins are preferable as the sliding layer of the bearing 1 of the compressor for the refrigerator in which the bearing 1 comes to a high temperature, since a thermostability is high, and a high-temperature strength is high. In other words, if these resins are used, the abrasion of the sliding surface of the bearing 1 is small, and the reduction of the compression efficiency caused by the axial deflection of the crank shaft 4 is hard to be generated.

Further, s solid lubricant may be included at 1 to 40 weight % in the resin sliding layer 3, for enhancing a sliding performance thereof. It is possible to employ any one or more of a molybdenum disulfide, a tungsten disulfide, a graphite, and a PTFE, as the solid lubricant. In this case, since the thermal expansion coefficient is small in the molybdenum disulfide, the tungsten disulfide and the graphite among the solid lubricant in comparison with the resin, the thermal expansion deformation of the resin sliding layer 3 becomes smaller at the starting time with respect to the regular operating time. Therefore, if the content of the solid lubricant goes beyond 40 weight %, an increasing amount of the bearing clearance C2 at the starting time becomes too small, and the direct contact between the sliding surface of the bearing 1 and the surface of the crank shaft 4 is apt to be generated. Accordingly, it is preferable that the content is equal to or less than 40 weight %.

Further, since the PTFE is a resin type solid lubricant in the same manner as the resin sliding layer 3, and a thermal expansion deformation amount thereof is large, the PTFE is most preferable as the solid lubricant which is used in the present invention. In the case of using a resin having a thermal expansion coefficient which is relatively lower in comparison with the PTFE, as the resin composition of the resin sliding layer 3, it is necessary to take into consideration a thermal expansion deformation of the resin sliding layer 3 in correspondence to a volume rate of the PTFE in the resin sliding layer 3.

Further, in the case that the PTFE is included as the solid lubricant, it may be included further by 0.1 to 15 weight % of at least one compound selected from a calcium phosphate, a barium phosphate, a magnesium phosphate, a lithium phosphate, a tribasic lithium phosphate, a tribasic calcium phosphate, a calcium hydrogen phosphate or anhydrate, a magnesium hydrogen phosphate or anhydrate, a lithium pyrophosphate, a calcium pyrophosphate, a magnesium pyrophosphate, a lithium metaphosphate, a calcium metaphosphate, a magnesium metaphosphate, a lithium carbonate, a magnesium carbonate, a calcium carbonate, a strontium carbonate, a barium carbonate, a calcium sulfate and a barium sulfate, for enhancing a lubricating characteristic of the PTFE.

1. A bearing device of a compressor for a refrigerator in which a cylindrical bearing comprising a steel back layer and a resin sliding layer rotatably supports a shaft via a clearance, wherein a thickness L (mm) of the resin sliding layer at a time of starting is set to the following range, with respect to a clearance C1 (mm) between the sliding surface of the bearing and the surface of the shaft at a time of a regular operation, a bearing temperature T2 (K) of the bearing at a time of the regular operation, a bearing temperature T1 (K) of the bearing at a time of starting, and a thermal expansion coefficient α (K−1) of a resin composition of the resin sliding layer:
C1×0.025/{(T2−T1)×α}≦L≦C1×0.20/{(T2−T1)×α}.

2. A bearing device of a compressor for a refrigerator as claimed in claim 1, wherein a porous metal sintered layer is formed on said steel back layer, and said resin sliding layer is coated on said porous metal sintered layer.

3. A bearing device of a compressor for a refrigerator as claimed in claim 1, wherein said resin sliding layer employs a resin having a thermal expansion coefficient which is relatively twentyfold or larger than a thermal expansion coefficient of a material of said shaft.

4. A bearing device of a compressor for a refrigerator as claimed in claim 2, wherein said resin sliding layer employs a resin having a thermal expansion coefficient which is relatively twentyfold or larger than a thermal expansion coefficient of a material of said shaft.

5. A bearing device of a compressor for a refrigerator as claimed in claim 1, wherein a resin composition of said resin sliding layer is constructed by any one or more of a polyimide, a polyamide-imide and a polybenzimidazole.

6. A bearing device of a compressor for a refrigerator as claimed in claim 2, wherein a resin composition of said resin sliding layer is constructed by any one or more of a polyimide, a polyamide-imide and a polybenzimidazole.

7. A bearing device of a compressor for a refrigerator as claimed in claim 3, wherein a resin composition of said resin sliding layer is constructed by any one or more of a polyimide, a polyamide-imide and a polybenzimidazole.

8. A bearing device of a compressor for a refrigerator as claimed in claim 4, wherein a resin composition of said resin sliding layer is constructed by any one or more of a polyimide, a polyamide-imide and a polybenzimidazole.

9. A bearing device of a compressor for a refrigerator as claimed in claim 1, wherein 1 to 40 weight % of solid lubricant is included in said resin sliding layer.

10. A bearing device of a compressor for a refrigerator as claimed in claim 2, wherein 1 to 40 weight % of solid lubricant is included in said resin sliding layer.

11. A bearing device of a compressor for a refrigerator as claimed in claim 3, wherein 1 to 40 weight % of solid lubricant is included in said resin sliding layer.

12. A bearing device of a compressor for a refrigerator as claimed in claim 4, wherein 1 to 40 weight % of solid lubricant is included in said resin sliding layer.

13. A bearing device of a compressor for a refrigerator as claimed in claim 5, wherein 1 to 40 weight % of solid lubricant is included in said resin sliding layer.

14. A bearing device of a compressor for a refrigerator as claimed in claim 6, wherein 1 to 40 weight % of solid lubricant is included in said resin sliding layer.

15. A bearing device of a compressor for a refrigerator as claimed in claim 7, wherein 1 to 40 weight % of solid lubricant is included in said resin sliding layer.

16. A bearing device of a compressor for a refrigerator as claimed in claim 8, wherein 1 to 40 weight % of solid lubricant is included in said resin sliding layer.

17. A bearing device of a compressor for a refrigerator as claimed in claim 9, wherein said solid lubricant is constructed by any one or more of a molybdenum disulfide, a tungsten disulfide, a graphite, and a polytetrafluoroethylene.

18. A bearing device of a compressor for a refrigerator as claimed in claim 17, wherein in the case that said polytetrafluoroethylene is included as said solid lubricant, it is included further by 0.1 to 15 weight % of at least one compound selected from a calcium phosphate, a barium phosphate, a magnesium phosphate, a lithium phosphate, a tribasic lithium phosphate, a tribasic calcium phosphate, a calcium hydrogen phosphate or anhydrate, a magnesium hydrogen phosphate or anhydrate, a lithium pyrophosphate, a calcium pyrophosphate, a magnesium pyrophosphate, a lithium metaphosphate, a calcium metaphosphate, a magnesium metaphosphate, a lithium carbonate, a magnesium carbonate, a calcium carbonate, a strontium carbonate, a barium carbonate, a calcium sulfate and a barium sulfate.
